(19) United States
(12) Patent Application Publication
(10) Pub. No.: US 2025/0182458 A1
(43) Pub. Date: Jun. 5, 2025

(54) SYSTEMS AND METHODS OF ANALYZING ASSAY IMAGES OF VIRUS STRAINS USING ARTIFICIAL INTELLIGENCE

(71) Applicants: ImmunityBio, Inc., Culver City, CA (US); University of Witswatersrand, Johannesburg, Johannesburg (ZA)

(72) Inventors: Mustafa I. Jaber, El Segundo, CA (US); Kamil A. Wnuk, El Segundo, CA (US); Bavesh Davandra Kana, Johannesburg (ZA); Bhavna Gowan Gordhan, Johannesburg (ZA); Christopher Shawn Ealand, Johannesburg (ZA)

(21) Appl. No.: 18/956,685

(22) Filed: Nov. 22, 2024

Related U.S. Application Data
(60) Provisional application No. 63/604,455, filed on Nov. 30, 2023.

(51) Int. Cl. G06V 10/776; G06V 10/70; G06V 10/74; G06V 10/82

(52) U.S. Cl. CPC G06V 10/776; G06V 10/761; G06V 10/82; G06V 10/87; G06V 2201/04

(57) ABSTRACT

Disclosed systems and methods include generating augmented images based on an image, processing, using two or more neural networks, each of the augmented images and the image, determining, for each of the two or more neural networks, a fitness metric, and determining a performance of each of the two or more neural networks based on the determined fitness metric. Disclosed systems and methods also include selecting one or more neural networks, processing, using the selected one or more neural networks, a plurality of images, generating, with the selected one or more neural networks, an association of each image of the plurality of images with one of a plurality of clusters, generating a correlation coefficient, and determining a degree of correlation between a first variant and a second variant of the plurality of variants.

### CROSS-REFERENCE TO RELATED APPLICATIONS

This application claims the benefit of priority under 35 U.S.C. § 119(e) to U.S. Provisional Application Ser. No. 63/604,455, filed Nov. 30, 2023. The entire disclosure of U.S. Provisional Application Ser. No. 63/604,455 is incorporated herein by reference in its entirety.

### FIELD OF THE DISCLOSURE

The invention relates generally to systems and methods for analyzing image data and particularly to identifying correlations between strains of viruses by analyzing images using convolutional neural networks (CNNs).

### BACKGROUND

Viruses exert a profound impact on global landscapes, influencing public health, economies, and social structures. The advent of novel viruses can trigger pandemics, resulting in widespread disease, death, and considerable disruption to daily life. The ongoing COVID-19 pandemic, for example, triggered by severe acute respiratory syndrome coronavirus 2 (SARS-CoV-2), provides a stark example of how a single virus can alter the trajectory of human history.

Different strains of viruses can display significantly different behaviors. These behaviors hinge primarily on their genetic characteristics, which in turn dictate various properties such as the severity of disease they cause, their transmissibility, the range of organisms they can infect, and their susceptibility to vaccines. For instance, the original strain of SARS-CoV-2 exhibited a certain level of transmissibility and virulence, whereas subsequent strains, like the Delta variant, demonstrated significantly higher transmissibility.

Understanding the correlations between the behaviors of different strains is integral to predicting and managing pandemics and other outbreaks. Knowledge that certain strains exhibit similar behaviors in terms of transmission dynamics or response to environmental factors could aid in forecasting the probable impact of a new variant. Additionally, understanding whether infection with one variant confers immunity to others can shape public health strategies, including vaccination campaigns.

Typically, characterization of emerging variants comprises sequencing and testing of viral cytotoxicity in tissue culture assays that employ Vero E6 cells. In the latter, a tissue-culture infectious dose 50 (TCID50), the titer at which 50% of the cells in culture will die, is established. Both these analyses provide information that is useful for understanding the characteristics of variants that become predominant and may be useful for predicting whether or not a novel variant has the potential to become a predominant circulating strain during a pandemic.

### SUMMARY

There is a need for a system and method capable of automatically assessing the ability for a neural network to analyze images of viruses. Also, there is a need for a system and method capable of automatically and/or remotely identifying correlations between different strains of viruses. Understanding correlations between behaviors of different strains of viruses is integral to predicting and managing future and ongoing pandemics. As described herein, one or more image-based artificial intelligence (AI) systems, such as CNNs, can be tested to determine their capability or performance in analyzing particular types of images. Based on the determined performance, one or more AI systems may be selected and used to identify correlations between images. Such correlations may be used to identify correlations between different strains of a virus and/or correlations in other imageable data.

Assay images, such as images from cell culture well plates (i.e., well images), typically derived from high-content screening (HCS) or high-throughput screening (HTS), are powerful tools used in virology research to visualize and quantify viral growth over time. In this process, cells are often infected with a virus and then cultivated in multi-well plates, and images of each well are captured at various time points using automated microscopy. By employing fluorescent staining or tagging methods, researchers can visualize the viral infection process, tracking changes in cell morphology, the extent of cell death, or the spread of the virus within the well. The images generated provide a detailed temporal and spatial record of viral growth and its effects on cells. As such, assay well images are valuable in understanding the life cycle of viruses, evaluating the impact of potential antiviral treatments, and identifying the conditions that affect viral replication rates.

Systems and methods described herein may be used to determine correlations between viruses as evidenced by images of assay wells as determined by an AI system and to determine how well particular types of CNNs can analyze assay well images. Such correlations may be used to determine characteristics of future viruses and/or virus strains by correlating new images of viruses with known strains.

Comparing the performance of different off-the-shelf CNNs as described herein is a beneficial practice for several reasons. Off-the-shelf models, also known as pre-trained models, have already been trained on large, general-purpose datasets and have proven their effectiveness at image classification tasks. However, their performance can vary significantly depending on the specific problem at hand. By comparing different models on the same dataset, it is possible to identify which architecture or CNN is most suitable for a given task. Furthermore, this process can save significant time and resources compared to training a model from scratch. Selecting the best-performing off-the-shelf model can serve as a starting point for further fine-tuning, allowing for the development of highly effective, task-specific image analysis tools.

As described herein, CNNs can be highly effective at pattern recognition in images and may be harnessed to analyze correlations between different strains of a virus. For example, in the context of viral research, scientists may capture detailed images of assay wells infected with different virus strains. CNNs could be used to analyze these images and recognize distinct patterns associated with each strain. By comparing the visual patterns in assay well images, CNNs may be used to uncover correlations and differences in the ways such strains interact with host cells, proliferate, or cause cell damage.

Understanding these correlations through the use of CNNs can be beneficial in multiple ways. Firstly, it can accelerate the research process. Traditionally, quantifying and comparing the characteristics of different viral strains can be labor-intensive and time-consuming. With CNNs, this process can be significantly automated and scaled up, allowing researchers to analyze a larger number of strains in less time. Secondly, these correlations can inform the development of antiviral strategies. If a correlation implies a shared vulnerability across different strains, it may be possible to develop treatments that are effective against multiple strains. Furthermore, understanding the differences between strains can guide the development of strain-specific interventions or help predict how a new strain might behave based on its similarity to known strains.

These and other needs are addressed by the various embodiments and configurations of this disclosure. The systems and methods of this disclosure provide a number of advantages depending on the particular configuration, and these and other advantages will be apparent from this disclosure.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures, wherein:

FIG. 1 is an illustration of a computing environment in accordance with one or more of the embodiments described herein;

FIG. 2 is a block diagram of a machine learning system in accordance with one or more of the embodiments described herein;

FIG. 3 is an illustrative image of an assay well slide which may be used in accordance with one or more of the embodiments described herein;

FIG. 4 is an illustrative assay well image which may be used in accordance with one or more of the embodiments described herein;

FIG. 5 is a graph showing results of methods and systems in accordance with one or more of the embodiments described herein;

FIG. 6 is a graph showing results of methods and systems in accordance with one or more of the embodiments described herein;

FIG. 7 is a flowchart of a method in accordance with one or more of the embodiments described herein; and

FIG. 8 is a flowchart of a method in accordance with one or more of the embodiments described herein.

### DETAILED DESCRIPTION

As described above, the mechanisms underlying fitness of SARS-CoV-2 mutations that enable certain variants to become dominant are not fully understood. As described herein, systems and methods of identifying correlations in the pattern of viral cytotoxicity, as assessed by cytopathic effect (CPE) in Vero E6 cells infected with different SARS-CoV-2 variants, are provided.

In addition to information provided by TCID50 analysis, images of individual cell culture wells from TCID50 assays, wherein Vero E6 cells were infected with various SARS-CoV-2 variants may be processed by CNNs to transform the images into an embedding space better suited to characterize similarities or differences in the patterns of cytotoxicity elicited by strains of viruses such as the Wuhan, Beta, Delta, or Omicron strains of SARS-CoV-2. While the systems and methods described herein relate generally to SARS-CoV-2, it should be appreciated that the same or similar systems and methods may be applied to images of other viruses and/or anything which may be represented visually.

As an example of the systems and methods described herein, an analysis based on five different CNNs from Inception, ResNet, and DenseNet families may be performed to characterize images from tissue culture infectious dose (TCID) assay wells for the ancestral (Wuhan), Beta, Delta, and Omicron variants of SARS-CoV-2-infected Vero E6 cell cultures. Findings were then confirmed in a refined dataset of images that excluded images without evidence of CPE. For both the complete and refined datasets, the cytotoxicity patterns in Beta and Delta variants were found to be highly similar, whilst the ancestral Wuhan variant was found to be dissimilar from all other variants analyzed. The CNN-based approach described herein to characterize and compare visual CPE of cultures infected with known and emerging viral variants may be useful to determine how clusters of co-occurring mutations affect viral cytotoxicity, and whether certain patterns of CPE can be predictors of variant behavior, such as transmissibility and disease severity, in human hosts. While the systems and methods described herein refer to SARS-CoV-2 as an example, it should be appreciated that the same or similar systems and methods may be used to monitor any viral growth in any cell type or tissue. As a non-limiting example, the same or similar systems and methods may be used to monitor human coronaviruses (NL63, 229E, OC43, HKU1, SARS, MERS, SARS-CoV-2) that mutate in ways leading to suspicion of pandemic potential and/or any present and/or future animal viruses where there is cause for concern of jumping to humans or impacting the global food supply.

The ensuing description provides embodiments and examples only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably, and include any type of methodology, process, mathematical operation, or technique.

The term “means” as used herein shall be given its broadest possible interpretation in accordance with 35 U.S.C. Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

For purposes of explanation, numerous details are set forth in order to provide a thorough understanding of the present disclosure. It should be appreciated, however, that the present disclosure may be practiced in a variety of ways beyond the specific details set forth herein.

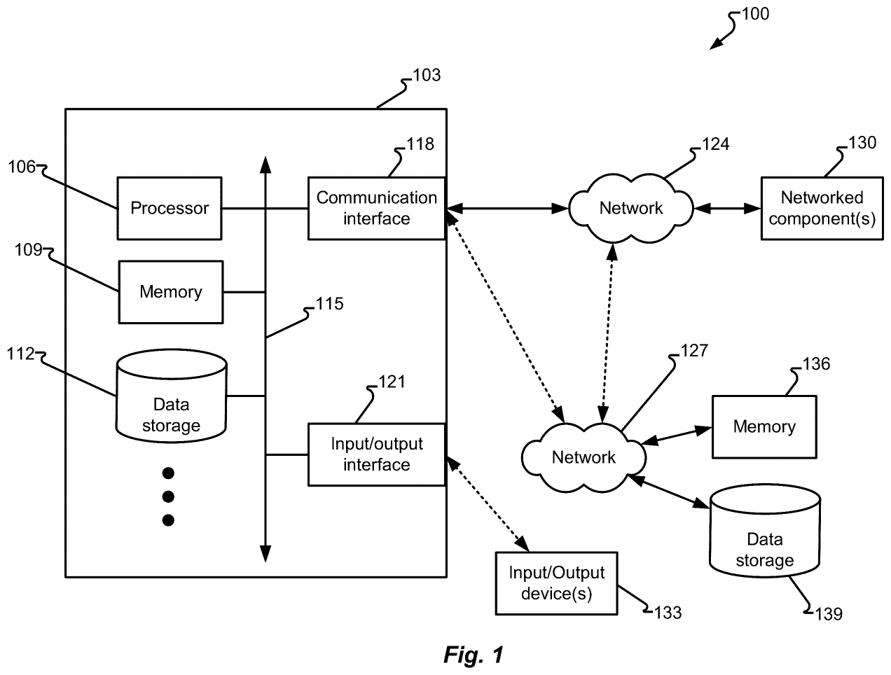

FIG. 1 depicts a computer system 103 in a computing environment 100 in accordance with embodiments of the present disclosure. In some embodiments, a method of analyzing assay well images and determining performances of CNNs as described herein may be performed by a computer system 103 existing in a computing environment 100 as illustrated in FIG. 1. In one embodiment, a device for analyzing well images and determining performances of CNNs may be embodied, in whole or in part, as computer system 103 comprising various components and connections to other components and/or systems.

The components are variously embodied and may comprise processor 106. The term “processor,” as used herein, refers exclusively to electronic hardware components comprising electrical circuitry with connections (e.g., pinouts) to convey encoded electrical signals to and from the electrical circuitry. Processor 106 may comprise programmable logic functionality, such as determined, at least in part, from accessing machine-readable instructions maintained in a non-transitory data storage, which may be embodied as circuitry, on-chip read-only memory, memory 109, data storage 112, etc., that cause the processor 106 to perform steps of the instructions.

Processor 106 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 115, executes instructions, and outputs data, again such as via bus 115. In other embodiments, processor 106 may comprise a shared processing device that may be utilized by other processes and/or process owners, such as in a processing array within a system (e.g., blade, multi-processor board, etc.) or distributed processing system (e.g., “cloud,” farm, etc.). It should be appreciated that processor 106 is a non-transitory computing device (e.g., an electronic machine comprising circuitry and connections to communicate with other components and devices).

Processor 106 may operate a virtual processor, such as to process machine instructions not native to the processor (e.g., translate an operating system and machine instruction code set to enable applications to execute on a virtual processor), however, as those of ordinary skill understand, such virtual processors are applications executed by hardware, more specifically, the underlying electrical circuitry and other hardware of the processor (e.g., processor 106). Processor 106 may be executed by virtual processors. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 106, computer system 103 may utilize memory 109 and/or data storage 112 for the storage of accessible data, such as instructions, values, etc. Communication interface 118 facilitates communication with components, such as processor 106 via bus 115 with components not accessible via bus 115. Communication interface 118 may be embodied as a network port, card, cable, or other configured hardware device. Additionally, or alternatively, human input/output interface 121 connects to one or more interface components to receive and/or present information (e.g., instructions, data, values, etc.) to and/or from a human and/or electronic device. Examples of input/output devices 133 that may be connected to input/output interface include, but are not limited to, keyboard, mouse, trackball, printers, displays, sensor, switch, relay, speaker, microphone, still and/or video camera, etc. In another embodiment, communication interface 118 may comprise, or be comprised by, human input/output interface 121. Communication interface 118 may be configured to communicate directly with a networked component or utilize one or more networks, such as network 124 and/or network 127.

Network 124 may be a wired network (e.g., Ethernet), a wireless network (e.g., Wi-Fi, Bluetooth, cellular, etc.), or a combination thereof and may enable computer system 103 to communicate with networked component(s) 130. In other embodiments, network 124 may be embodied, in whole or in part, as a telephony network (e.g., public switched telephone network (PSTN), private branch exchange (PBX), cellular telephony network, etc.).

Additionally, or alternatively, one or more other networks may be utilized. For example, network 127 may represent a second network, which may facilitate communication with components utilized by computer system 103. For example, network 127 may be an internal network to a business entity or other organization, whereby components are trusted (or at least trusted to a degree), where networked component(s) 130 connected to a public network (e.g., Internet) such as network 124 may not be trusted (or at least trusted to a lesser degree).

Components attached to network 127 may include memory 136, data storage 139, input/output device(s) 133, and/or other components that may be accessible to processor 106. For example, memory 136 and/or data storage 139 may supplement or supplant memory 109 and/or data storage 112 entirely or for a particular task or purpose. As another example, memory 136 and/or data storage 139 may be an external data repository (e.g., server farm, array, “cloud,” etc.) and enable computing device 103, and/or other devices, to access data thereon. Similarly, input/output device(s) 133 may be accessed by processor 106 via human input/output interface 121 and/or via communication interface 118 either directly, via network 127, via network 124 alone (not shown), or via networks 127 and 124. Each of memory 109, data storage 112, memory 136, data storage 139 comprise a non-transitory data storage comprising a data storage device.

It should be appreciated that computer-readable data may be sent, received, stored, processed, and presented by a variety of components. It should also be appreciated that components illustrated may control other components, whether illustrated herein or otherwise. For example, one input/output device 133 may be a router, switch, port, or other communication component such that a particular output of processor 106 enables (or disables) input/output device 133, which may be associated with network 124 and/or network 127, to allow or disallow communications between two or more nodes on network 124 and/or network 127. One of ordinary skill in the art will appreciate that other communication equipment may be utilized, in addition or as an alternative, to those described herein without departing from the scope of the embodiments.

As a result, and in one embodiment, processor 106 may execute instructions to perform the systems and methods described herein. In another embodiment, networked component(s) 130 may execute one or more systems and methods while processor 106 may execute one or more other systems and methods. Memory values may be read from memory 109 or a memory of one or more network component(s) 130. In another embodiment, outputs from systems and methods as described herein may be maintained in memory 136 and/or data storage 139.

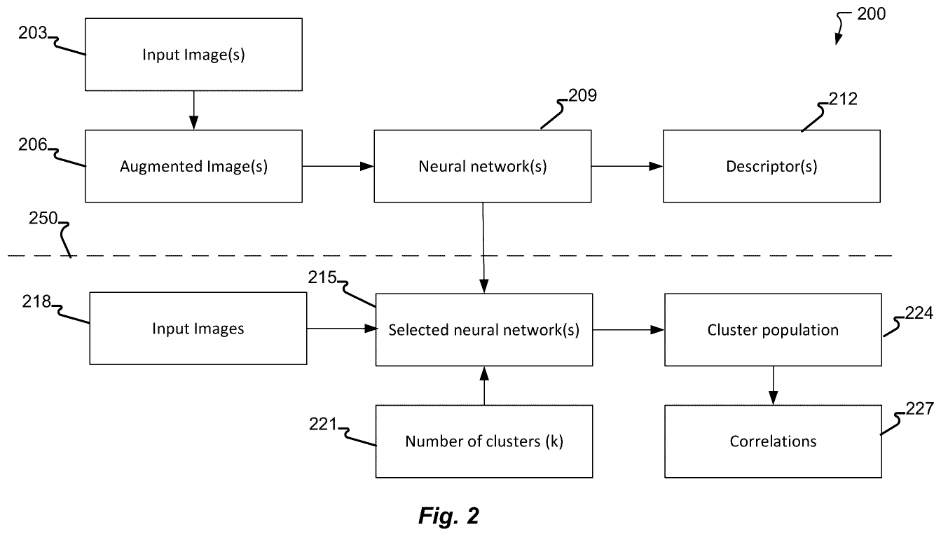

The computer system 103 may be configured to execute a machine learning (ML) system 200 as illustrated in FIG. 2. In some embodiments, the ML system 200 may comprise a first testing element and a second testing element, in which the first testing element, illustrated as the elements above the dashed line 250, may be used to assess performance of CNNs 209, such as off the shelf CNNs, for processing input images 203, while the second testing element, illustrated as the elements below the dashed line 250, may be used to use selected CNNs 215 to identify correlations between input images 218.

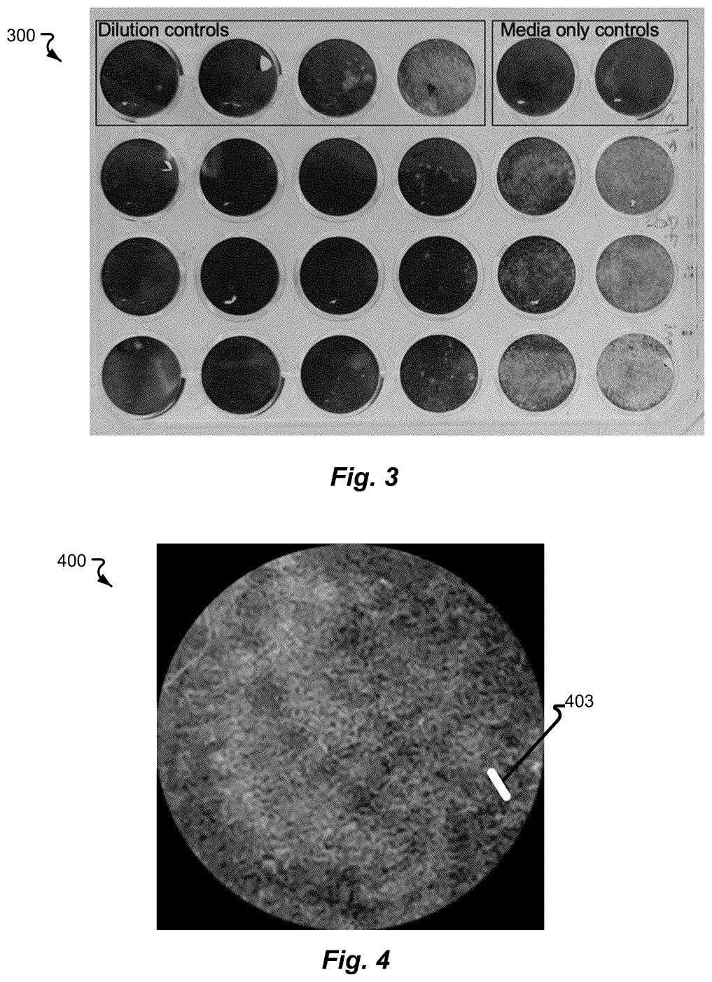

Input images 203 as described herein may be sourced from assay plates such as a 24-well culture plate 300 as illustrated in FIG. 3. In some implementations, adherent monkey Vero E6 cells may be cultured in flasks and maintained in complete Dulbecco's Modified Eagle's Medium (DMEM), prepared fresh by combining 45 mL of DMEM containing L-glutamine with 5 mL fetal bovine serum (FBS) and 50 g/mL gentamycin. Flasks may be incubated at 37° C. with 5% CO₂ and growth monitored to 70-80% confluency. Once the cells reach the required confluency (>80%), the media may be removed, and the cells treated with 5 mL of TripleX (GIBCO™) for 10-15 min at 37° C. The dislodged cells from multiple flasks may be pooled in a 50 mL Falcon tube to which complete DMEM may be added, and the cells centrifuged at 1000 rpm for 5 min. The supernatant may be discarded, and the cell pellet resuspended in the residual media. The cell count per mL may be measured using the Countess II (INVITROGEN™) and Trypan Blue. An appropriate amount of DMEM may be added to the Vero E6 cells for seeding at 1×105 cells/ml in 24-well culture plates. The plates may be incubated overnight at 37° C. with 5% CO₂.

All four variants of SARS-CoV-2 circulating in South Africa may be expanded from either viral supernatants (Wuhan) or isolated from patient swabs (Beta, Delta, and Omicron) obtained from the National Health Laboratory Service and the National Institute for Communicable Diseases of South Africa (13). Frozen aliquots of the various SARS-CoV-2 variants with approximately 105 virons/mL may be thawed and appropriate dilutions of each variant were generated in DMEM.

The tissue culture infectious dose (TCID) assays may be carried by infecting the seeded Vero E6 cells the following day with 250 μL of the appropriate dilutions of the various SARS-CoV-2 variants. The infection may be carried out for one hour at 37 degrees Celsius with 5% CO₂ after which 250 μL of overlay media (DMEM containing 4% FCS and 2 mL (3%) agarose) may be added on top of the inoculum and the plates incubated at 37 degrees Celsius with 5% CO₂ for 3 days (72 hours). An uninfected well (media only) may be included as a negative control.

After 3 days of SARS-CoV-2 infection, the zones of clearance (plaques) may be fixed for 20 min at room temperature by placing 500 μL of 8% formaldehyde on top of the overlay media. After 20 min, the supernatant may be removed, and the viable cells may be stained with 250 μL of 1% crystal violet for 5 min. The crystal violet may be removed, and the wells rinsed with 500 μL of PBS. Images of the zones of clearance may be taken using a camera with a 5.4 mm lens and an f/1.8 aperture, 1/90 aperture speed and ISO160. The 12.0-megapixel images may be captured at 3000×4000 resolution (RAW format).

On each 24-well plate, 6 wells were used for each variant and each variant may be tested 18 times, giving a total of 108 wells for each variant. As illustrated in FIG. 3, a 24-well culture plate 300 may contain 24 different wells, each containing a different sample. An image of each well in the well culture plate may be captured separately, or in some implementations, an image of the well culture plate 300 may be captured in whole and a separate image of each well may be created by cropping the image of the well culture plate 300.

While the above description of the creation of variant samples and images provides specific details, it should be appreciated any type of image may be used. The images of the wells may be captured using any type of lens and image sensor at any particular distance.

In an example scenario, a tissue culture well image set used for analysis includes raw images from 24-well assay plates wherein Vero E6 cells were infected with SARS-CoV-2 variants. Each 24-well plate may contain dilution controls and media-only controls which may not be used for analysis. For each variant, images of six wells, i.e., regions of interest (ROI) may be captured. Each captured ROI may have an area of 1200 pixels (px)×1800 px.

As illustrated in FIG. 4, a well image 400 may be created by capturing or creating an image of a well from the well culture plate 300 and adding a masked area surrounding the circle of the well. A black mask may be used to eliminate non-well components (such as the walls of the well) by centering, for example, a 300 px×300 px region of each image. An example final captured image for analysis were 200 px×200 px. Images created in this way may be used both for selecting neural networks for analyzing images as well as for analyzing using selected neural networks through the systems and methods as described herein.

Images qualifying for inclusion in the refined dataset may be images of cultures which show zones of clearance throughout the majority of a well, or show non-uniform partial clearance, described as variegated (a pattern resulting from plaque formation). In some implementations, images may be converted to grayscale in which perfectly white pixels are associated with a value of one, and perfectly black pixels are associated with a value of zero. Well images whose average value over all pixels may be greater than 0.75 may be included in a refined set. An image also may qualify for the refined image set if the standard deviation across all pixels may be greater than 0.1, an assessment of variegation. It should be appreciated that the above-noted details relating to the inclusion of images in a refined set are provided for example purposes only and should not be considered as limiting in any way.

Such well images are useful for analysis using artificial intelligence (AI) as described herein as the growth of viruses can be detected by a CNN. For example, a virus in an image of a well may appear as white. As the virus grows in the well, the amount of white in the well may increase. By capturing images of different wells after the virus has grown for some time, the growth (or non-growth) of the virus in each well can be compared by analyzing the captured images using AI as described herein.

Augmented images 206 as described herein may be created from the input images 203. Depending on the amount of testing data available, it may be beneficial to create additional well images for testing, training, or analysis purposes. In some implementations, augmented images may be generated by augmenting an original well image by rotating, shifting, shearing, flipping, or otherwise modifying the well image. In some implementations, a combination of rotating, flipping, shifting, and shearing may be used to augment a well image. A rotation as described herein may be a rotation to a set degree, such as 90, 180, 270, or to a random position. An augmented image may be generated by flipping an original well image vertically, horizontally, or on any angle. Creating augmented versions of original well images may enable each well image to be considered robustly, whether for testing performance of a neural network or for analyzing the well image.

Also, using augmented versions of original well images for training purposes may ensure that positional information relating to visual characteristics of well images are not given excessive weight. For example, the well image 400 of FIG. 4 includes a white area 403 in a bottom right quadrant. Such white areas in well images may be evidence of growth of a virus. By generating augmented versions of this well image 400 in which the white area 403 appears in other areas and/or at other angles, the particular placement and angle of the white area 403, a neural network trained on the well image 400 and augmented versions of the well image 400 may be less likely to associate other well images with white areas in the lower left quadrant with the well image 400 based solely on the placement and/or angle of the white area 403 in the well image 400.

When an input image is processed by a neural network as described herein, a descriptor may be output. By generating augmented versions of each image and processing each image and the augmented versions with one or more neural networks, many descriptors may be created for any given original well image, ensuring that the qualities of each image are encoded in the training data regardless of orientation.

As an example, for each input well image, six augmented versions may be generated, including four versions of the well image rotated at different degrees, a horizontally flipped version, and a vertically flipped version.

In an example scenario, a total of 432 original images of individual wells of SARS-CoV-2 infected cells may be utilized. The 432 original images may be augmented by capturing images with 90-degree, 180-degree, and 270-degree rotations, as well as images that had been flipped horizontally and vertically. This results in a total of 2,592 well images (4 variants×6 assay images per variant×18 wells per assay image×(well image+5 augmentations per well image)) for analysis.

In some implementations, a data set of images may be refined by initially transforming the images into grayscale. This could involve an algorithmic process that converts each image to grayscale. Next, a determination may be made concerning the percentage of white pixels present in each image. This percentage may serve as an effective metric to measure the ‘whiteness’ of an image, (or a whiteness metric) and could be calculated by dividing the number of white pixels by the total number of pixels in the image, then multiplying the quotient by 100.

In some implementations, a whiteness metric may include a percentage of white pixels, a standard deviation, or a combination of both. A standard deviation calculation may provide an additional measure of the dispersion of white pixels within an image.

To curate a suitable and consistent dataset, a system, such as a computing system 103, may be programmed to exclude images that do not meet certain criteria. For instance, images that have less than 75% white pixels or have a standard deviation value of less than 0.1 might be removed from the data set. This approach could ensure that the remaining images within the data set share a similar degree of whiteness, thereby leading to a more focused analysis and potentially more reliable outcomes from the subsequent CNN processing.

Neural networks 209 as described herein may be CNNs or other types of deep learning models capable of performing image recognition tasks. Such models may be designed to process data, such as images. Off-the-shelf CNNs are pre-trained models that have been trained on large datasets, and they may provide a means to leverage existing neural network architectures proven successful for image classification tasks. For example, ResNet-34, a variant of the Residual Network (ResNet) family, may utilize 34 layers and introduce skip connections or shortcuts to allow gradients to flow through the network directly.

Inception v3, another off-the-shelf model, is a version of the Inception family that may be characterized by its use of mini-networks within the overall network, helping to keep computational demand low while enabling the model to learn more complex representations. ResNet-152, with its 152 layers, takes the ResNet architecture to a much deeper level, potentially capturing more complex patterns in data.

DenseNet-169 and DenseNet-201 are members of the Dense Convolutional Network (DenseNet) family, which connects each layer to every other layer in a feed-forward fashion, contrasting with the ResNet models. DenseNet-169 and DenseNet-201 may refer to models with 169 and 201 layers, respectively. DenseNets may alleviate the vanishing-gradient problem, strengthen feature propagation, encourage feature reuse, and substantially reduce the number of parameters, making these models computationally efficient.

In some implementations, the output of each CNN 209 for each input image 203 and augmented image 206 may be considered a descriptor 212 or a feature vector. The descriptor may contain high-level features extracted from the input data, for instance, each input image 203 and augmented image 206. Through the convolutional layers and subsequent layers such as pooling and fully connected layers, the CNN may reduce the spatial dimensions of the input data, summarizing the input data into a compact representation that captures the most salient and discriminative features.

These extracted features or descriptors may be considered an abstract representation of the input, capturing various aspects such as shapes, textures, or colors in the context of images. Such descriptors may retain essential information necessary for a specific task like classification, detection, or segmentation, while disregarding redundant or irrelevant details. For example, in an image classification task, the descriptor may capture the presence and arrangement of particular shapes and textures in the image.

Neural networks as described herein may in some implementations be off-the-shelf or pretrained CNNs such as ResNet-34, Inception v3, ResNet-152, DenseNet-169, DenseNet-201, or similar CNNs, using pre-trained weights. In some implementations, neural networks may be custom-trained CNNs which may use an off-the-shelf CNN as a base before training is conducted using a training set of images such as well images.

In an example scenario, to identify morphological similarities and differences between wells with SARS-CoV-2-infected Vero E6 cells, image embeddings may be analyzed using a plurality of different CNNs. For example, in some implementations, five CNNs, including ResNet-34, Inception v3, ResNet-152, DenseNet-169, and DenseNet-201, may be used. When provided an input image 203 or an augmented image 206, each CNN may generate a distinct image embedding space, where each image 203 or augmented image 206 is represented by a descriptor 212 or vector encoding visual properties of the original image 203 or augmented image 206. Due to distinct network topologies and training methodologies, the embedding space of each CNN may encode visual properties differently, thus motivating an exploration of multiple embeddings to reach a robust conclusion.

The generated descriptor for each of the first one or more augmented images and the first image comprises a plurality of bins. The descriptor output by each CNN 209 may be, for example, a one-dimensional descriptor or a vector containing a plurality of bins. Each bin may be a different datapoint which may be used to compare outputs generated by a CNN 209 from different input images 203 and/or augmented images 206.

For each of the neural networks 209, a fitness metric associated with the descriptor for each of the input images may be determined. For each input image 203 and each augmented image 206 processed by a CNN 209, an associated descriptor 212 may be generated.

For example, for a first input image 203 and six augmented images 206 created from the first input image 203, seven descriptors 212 may be generated, with a first descriptor 212 being associated with the first input image 203 and six other descriptors 212 being associated with a respective one of the six augmented images.

A fitness metric may be calculated by comparing descriptors 212 associated with different input images 203 or augmented images 206. A CNN 209 may be considered as performing optimally if the descriptor 212 for an input image 203 is relatively similar to descriptors 212 for each of the augmented images 206 created from the input image 203.

Such a fitness metric may, for example, be a Euclidean distance between the descriptor 212 for a first input image 203 and descriptors 212 for a plurality of other input images 203 and descriptors 212 for a plurality of augmented images 206 created from each of the input images 203.

By comparing a similarity (or other fitness metric) between descriptors 212 associated with a plurality of input images 203 and descriptors 212 associated with augmented images 206 created from each of the plurality of input images 203, an overall performance of the CNN 209 processing the images 203, 206 may be determined.

As an example, generated augmented images 206 may be used to analyze embedding spaces of five CNNs 209 to develop a fitness metric to identify which CNN 209 may be more suitable for use in further analysis.

Since well images do not have a particular orientation, as one might find in photos of many common objects, it may be desirable for a CNN 209 to be as close as possible to being invariant to image rotation or other augmentations. This means that all augmentations of a certain image should be close to each other in the CNN embedding space, and also close to the original well image. To validate this hypothesis, nearest neighbors of each input image 203 may be identified. If each of the n nearest neighbors for a descriptor created from an input image 203 is a descriptor created from one of n augmented versions of the same input image 203, the CNN 209 may be considered to be well tuned for being invariant to augmentation.

As an example, in one study, 2,592 input images 203 were processed by five different CNNs 209 along with six augmented images 206 created from each input image 203. 648 of the input images 203 were captured from a well containing a Wuhan strain of SARS-CoV-2, 648 of the input images 203 were captured from a well containing a Beta strain of SARS-CoV-2, 648 of the input images 203 were captured from a well containing a Delta strain of SARS-CoV-2, and 648 of the input images 203 were captured from a well containing an Omicron strain of SARS-CoV-2. In the example study, the five CNNs were ResNet-34, Inception v3, ResNet-152, DenseNet-169, and DenseNet-201.

Next, for each descriptor 212 generated from an input image 203 for each CNN 209, a determination may be made as to whether all of its six nearest neighbors were descriptors 212 generated from augmented images 206 created from the same input image 203. A percentage showing how many of the input images 203 had associated augmented images 206 as nearest neighbors may be calculated for each CNN 209 and each strain.

As described above, a descriptor 212 may comprise a number of bins. Determining the Euclidean distance or fitness metric between the generated descriptor for each of one or more augmented images 206 and a generated descriptor for a first input image 203 may comprise determining a difference between values of each of the bins. For example, the original input image 203 may be processed by a CNN 209 and one or more augmented images 206 created from the original input image 203 may be processed by the CNN 209 to see how much the descriptor from the original input image 203 changes with each augmented image 206. A small or zero change (or a close spatial correlation) would indicate the CNN 209 is performing well.

Through such a system it may be determined whether a descriptor of an input image is most similar with descriptors of augmented versions of the input image or whether the descriptor of the input image is more similar to descriptors generated based on other images. As a result, one or more neural networks which can analyze images and detect similarities in images that are rotated, flipped, or otherwise created from the same image, and detect differences between images that are created from different images, such as different assay slide images, may be identified or selected.

A performance of a plurality of CNNs 209 may be determined based on the determined fitness metric for each respective CNN 209. In some implementations, the performance of each of the one or more CNNs 209 may be associated with a capability of assessing viral cytotoxicity. For example, a high performing CNN 209 may be well-tuned to identify different strains of a virus such as SARS-CoV-2.

Table 1, below, shows the frequency with which four of the five different CNNs 209 described above yielded six nearest neighbors all being augmented images 206 corresponding to the same original input image 203. ResNet-34 showed the least consistency in its ability to keep the proximity of the original image representation to its augmentations. Conversely, both DenseNet-169 and DenseNet-201 (not included in the table) consistently showed close proximity for an original image embedding and the rotated or flipped versions. Approximately 75% of all image representations were located in relatively close proximity to their augmentations in the two tested DenseNet CNNs 209. Similarly, ˜68% of the image embeddings in the ResNet-152 CNN 209 were close to all of their augmentations. From the study, it can be concluded that ResNet-152, DenseNet-169, and DenseNet-201 were high-quality CNNs 209 for the purpose of analysis of SARS-CoV-2 strain images.

TABLE 1
k-Nearest Neighbors of Vector Embedding
in Different CNN Embedding Spaces.

| | ResNet-34 | | Inception v3 | | ResNet-152 | | DenseNet-169 | |
|---|---|---|---|---|---|---|---|---|
| | Images | | Images | | Images | | Images | |
| SARS- | with 6 | | with 6 | | with 6 | | with 6 | |
| CoV-2 | matching | | matching | | matching | | matching | |
| strain | neighbors | % | neighbors | % | neighbors | % | neighbors | % |
| Wuhan | 306 | 47 | 401 | 61 | 473 | 72 | 504 | 77 |
| Beta | 181 | 27 | 337 | 52 | 400 | 61 | 476 | 73 |
| Delta | 257 | 39 | 363 | 56 | 447 | 68 | 478 | 73 |
| Omicron | 268 | 41 | 353 | 54 | 438 | 67 | 475 | 73 |
| Total | 1012 | 39 | 1454 | 56 | 1758 | 67 | 1933 | 74 |

After determining a performance of each of the CNNs 209, the CNNs 209 may be ranked. In some implementations, the percentages for images 203 from different strains may be averaged to determine an overall score. In this way, the CNNs 209 may be analyzed for performance based on sets of images as well as based on a total or average score. Based on the determined performance, one or more of the neural networks may be selected for performing analysis of images as described below in the second phase below the dashed line 250 of FIG. 2.

Because well images from viral variants elicit similar cytotoxic characteristics, it may be seen that such well images may have a similar distribution in an embedding space. Despite the distributions being complex, similar patterns of cytotoxicity—areas denuded of cells in the culture monolayer—may cluster near each other in local neighborhoods of embedding space. To account for distribution complexity, a K-means clustering algorithm may be used to partition the embedding space. Next, to quantify local similarity, a percentage of image data from each viral variant may be computed within every partition, and a correlation between the distributions of variants across partitions may be used as the final measure of cytotoxic pattern similarity between variants. This process may be as illustrated and described below in relation to FIG. 8 and the method 800.

The process of correlating well images of viral strains may be performed using input images 218 which may be the same as or similar to input images 203 as well as, in some implementations, augmented images created from the input images 218.

A group of input images 218 may be processed using one or more CNNs 215 which may be selected through a process as described above. Each of the CNNs 215 may use a particular number of clusters k to create a cluster population 224 from the group of input images 218. For example, the CNNs 215 may be used to associate each input image 218 with a cluster by performing k-means clustering. While in some implementations, the CNNs 215 may be off-the-shelf CNNs, it should be appreciated that the CNNs 215 may be trained to generate a variant label estimate for input images 218.

Each of the input images 218 may be labeled according to a source variant, such as a variant of a virus or a viral variant. Using the CNNs 215, variant populations may be computed for each partition, and correlations between variant distributions across partitions may be determined.

In some implementations, results of clustering using different k values may be compared to whether particular k values provide different results.

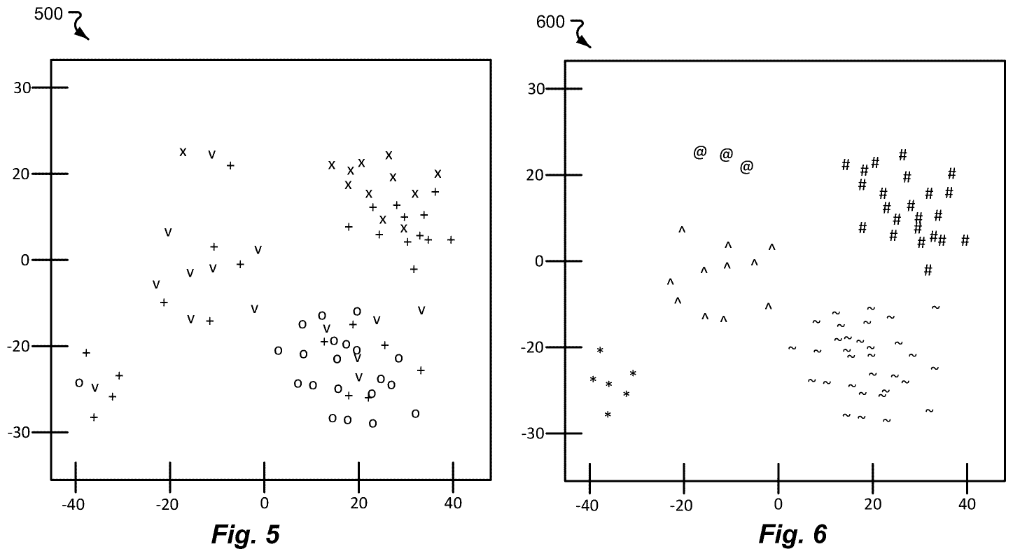

The output of the CNNs 215 may be a spatial distribution or correlation. A graph 500 in FIG. 5 illustrates spatial distributions from different sets of input images 218. While the graph 500 is two-dimensional, it should be appreciated that the two-dimensions are for illustrative purposes only and the spatial distributions of input images 218 may be in any dimension.

Each symbol (o, v, +, x) represents an input image 218. The different symbols (o, v, +, x) represent a different set. Images 218 from a first set are illustrated by an o, images 218 from a second set are illustrated by a v, images 218 from a third set are illustrated by a +, and images 218 from a fourth set are illustrated by an x. Each set may be associated with a different variant, such as a SARS-CoV-2 strain.

As should be appreciated, each CNN 215 may be used to generate a different spatial distribution of input images 218 and each different spatial distribution of input images 218 may be used to cluster input images 218.

Once a spatial distribution of the input images 218 is created using one or more CNNs 215, the input images 218 may be clustered into clusters as illustrated in FIG. 6. The number of clusters may vary and, in some embodiments, different clusterings may be used and compared.

In the graph 600 of FIG. 6, the same input images 218 in the spatial distribution of FIG. 5 are clustered into five clusters represented by symbols *, \hat{ }, @, #, and ˜. The clusters, such as the five clusters of FIG. 6, may be generated using K-means clustering by applying the K-means clustering to outputs of the CNNs 215.

For example, to demonstrate the complexity of local relationships between CPE patterns, a two dimensional visualization of DenseNet-169 image embeddings may be generated using t-distributed Stochastic Neighbor Embedding (t-SNE), showing Wuhan, Beta, Delta, and Omicron variants, such as in the graph 500 of FIG. 5, and the resulting partitions using a particular k value, such as k=5 as illustrated in FIG. 6. In some implementations, K-means clustering may be applied to original high dimensional CNN embeddings as opposed to 2D t-SNE representations.

Once clusters are generated, a correlation coefficient representing a correlation between different sets of images, such as images associated with different variants may be generated.

For example, based on the generated correlation between one or more sets of two or more variant labels and the association of each image with one of the clusters, determining, by the one or more processors, a degree of correlation between a first variant and a second variant of the plurality of variants. The degree of correlation between the first variant and the second variant indicates a pattern of cytotoxicity.

Finally, a correlation coefficient generated based on the association of each image may be compared with one of the plurality of clusters generated with a first neural network of the one or more neural networks with the association of each image with one of the plurality of clusters generated with a second neural network of the one or more neural networks.

Averaging, by the one or more processors, a correlation coefficient generated based on the association of each image with one of the plurality of clusters generated with a first neural network of the one or more neural networks with the association of each image with one of the plurality of clusters generated with a second neural network of the one or more neural networks.

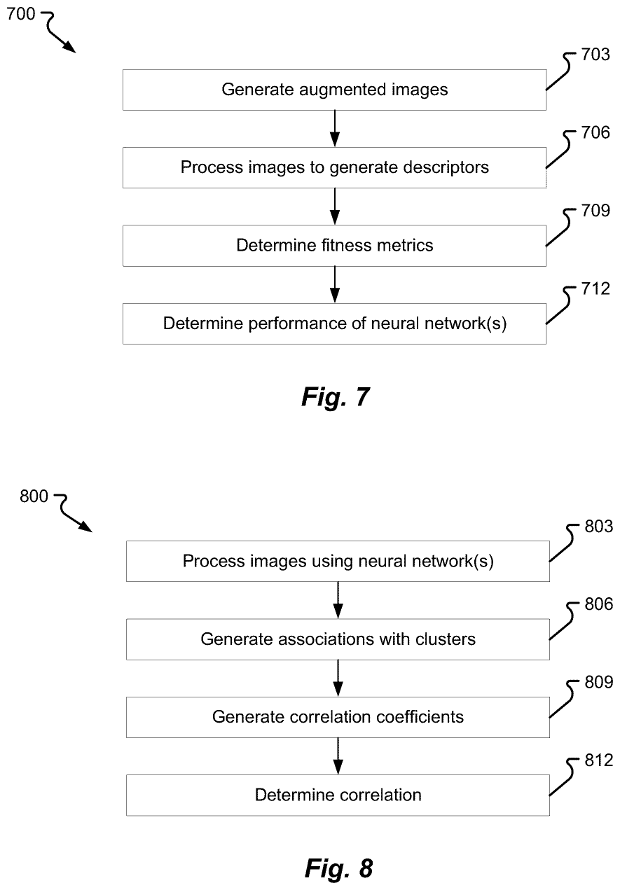

The above-discussed process of determining a performance of a CNN 209 may be performed as a method 700 as illustrated in FIG. 7. The method 700 may be performed using a computing system 103 as illustrated in FIG. 1. The method 700 may begin with one or more input images 203.

As described above, input images 203 may be associated with a particular variant. Each variant may be, for example, a SARS-CoV-2 strain or another virus strain.

At 703, one or more augmented images 206 may be created based on each of the input images 203. An augmented image 206 may be created by one or more of flipping and rotating an input image 203. In some implementations, a plurality of augmented images 206 may be created for each input image 203. In some implementations, other processing of input images 203 may be performed, such as grayscale conversion, filtering, and/or resizing.

At 706, each of the input images 203 and augmented images 206 may be processed using one or more neural networks 209 to generate a descriptor 212 for each input image 203 and each augmented image 206.

At 709, a fitness metric such as a Euclidean distance may be determined based on differences between the descriptor 212 for an input image 203 and the descriptors 212 for each of the other input images 203 and each of the augmented images 206. For example, a Euclidean distance may be determined measuring the Euclidean distance between an input image 203 and each of the other input images 203 and each of the augmented images 206. As a result, a plurality of Euclidean distance may be determined for each input image 203.

At 712, determine a performance of the one or more neural networks 209 based on the determined fitness metrics. In some implementations, performance of a neural network 209 may be determined based on a determination that the Euclidean distances between a descriptor 212 for an input image 203 and each of the descriptors 212 for augmented images 206 created from the input image 203 are less than descriptors 212 for other input images 203 and/or for other augmented images 206.

After determining the performance of the neural networks 209, in some implementations one or more of the neural networks 209 may be selected for use in analyzing images 218 as described herein.

The above-discussed process of correlating input images 218 may be performed as a method 800 as illustrated in FIG. 8. The method 800 may be performed using a computing system 103 as illustrated in FIG. 1. The method 800 may begin with a plurality of input images 218.

At 803, one or more input images 218 may be processed using one or more neural networks 215. In some implementations, the processing of an input image 218 using a CNN 215 may involve steps of extracting features from the input image 218. Initially, raw pixel data of the image 218 may be fed into the CNN 215. The input image 218 may be subject to several transformations such as resizing, normalization, and augmentation, which may be performed to enhance the robustness of the CNN 215 and optimize computational efficiency. In some implementations, the input image 218 may be converted to grayscale and/or other transformations may be performed. Additionally, in some implementations augmented versions of the input image 218 may be created and also processed using the CNN 215.

Initial layers of the CNN 215 may include convolutional layers enabling extraction of low-level features such as edges and color gradients. Such layers may apply filters to the image, generating a series of feature maps. Subsequent layers in the CNN 215 may include pooling or subsampling layers which may take sections of the feature map and summarize them, such as by using operations including max or average. As the image data passes through more convolutional and pooling layers, more complex features may be identified. For example, while the earlier layers may detect edges and textures, the later layers may recognize more sophisticated patterns like shapes and objects.

The final layers of the CNN may consist of fully connected layers, which may interpret the high-level features and perform classification or regression tasks. For instance, the output layer may employ a SoftMax function to generate probabilities for each class label. This approach may allow the model to determine the most probable class for the input image. Following this process, the CNN 215 may provide an output.

Each input image 218 may be associated with a particular class, such as a viral strain, or other identifying information. For example, an image set containing a plurality of images 218, each relating to one of a set of strains may be used. Upon completing the processing of the images 218, the CNN 215 may produce a spatial distribution or a feature map using the output based on each image. This spatial distribution may illustrate the locations and occurrences of distinctive features associated with each image 218.

In some implementations, spatial distributions obtained from processing a set of images through a CNN 215 may be utilized to associate data points with clusters. Each data point may correspond to a specific image or a feature within an image, and each cluster may represent a class or a category, such as a strain of a virus, within the set of images.

The spatial distribution of each class, represented by the feature maps, may be analyzed. These feature maps may encapsulate the spatial arrangement and intensity of learned features across different regions of the images. Next, a clustering algorithm, such as K-means, may be employed to partition these high-dimensional data points into distinct clusters. Such an algorithm may group data points based on similarities or proximity in the feature space, thereby ensuring that data points within the same cluster are more alike to each other than those in different clusters.

At 806, the clustering process may result in associations with cluster populations 224 being generated. In some implementations, after the formation of the cluster populations 224, the computing system 103 may perform an analysis comparing the distribution of classes (such as virus strains) within each cluster. In some implementations, the computing system 103 may create a frequency distribution or histogram of classes for each cluster, thereby noting the quantity of images in the cluster belonging to each class. For instance, if a cluster comprises a high percentage of images belonging to a similar class, it may suggest that the CNN and the clustering algorithm have accurately discerned and grouped together images with similar visual features, indicative of that class.

To further enhance the robustness of this process, the computing system 103 might also compute a measure of purity or homogeneity for each cluster. The purity may be a metric that represents the degree to which a cluster contains images from a single class. In an optimal scenario, a completely pure cluster would contain images only from one class, which might suggest that the CNN has successfully captured distinguishing features for that specific class.

At 809, coefficients of correlations 227 may be generated. For example, in some implementations, the computing system 103 may generate coefficients of correlation between classes based on the distribution of classes within the clusters. These coefficients may quantify the degree to which two classes co-occur within the same clusters, providing insight into their relationship.

To generate these correlation coefficients, the computing system 103 may construct a table for each pair of classes. Each entry in the table could indicate the number of times images from two classes co-occur within the same cluster. The correlation coefficients may then be computed from these tables.

At 812, a correlation between data associated with the processed images may be determined. For example, high correlation coefficients may suggest that the classes are closely related, while low or negative correlation coefficients may suggest that the classes are dissimilar or inversely related. These correlation coefficients may offer invaluable insights into the interplay between different classes, such as virus strains.

By use of CNN embeddings of TCID50 assay images, together with micro and macro spatial views of the deep learning embedding spaces, correlations between spatial patterns of cytotoxicity for different strains may be identified, such as between the Beta and Delta strains in Vero E6 cultures. As an example, findings may be confirmed using a refined image set (1,416 images). A similarity may be observed between the Delta and Omicron variants, with an average correlation value of 0.4396 from analysis of images using the high-quality embedding spaces, ResNet-152, DenseNet-169, and DenseNet-201; and a correlation value of 0.4018 when all five embedding spaces were considered. It may also be noted that the Wuhan strain is the most dissimilar in the cytotoxicity patterns it elicits when compared with the Beta, Delta, and Omicron strains.

Viral infectivity—the ability of the virus to enter and replicate inside the host cell—the release of virions to extracellular space, and subsequent infection of neighboring cells, all affect the pattern of cytotoxicity. The Delta variant has been reported to have a more rapid rate of replication, and ability to spread to neighboring cells as compared with the Alpha and Beta strains (Wuhan was not compared), and in a comparison of Beta, Delta, and Omicron, Delta displayed a relatively higher rate of RNA copy number increase, replication and infectivity than Beta and Omicron, and induced CPE at the earlier time point of 56 hours post-inoculation, compared with 72 hours for Omicron and 80 hours for Beta. In contrast, others reported observing evidence of CPE in Vero E6 culture earlier, at 48 hours, and at a similar level for both Delta and Beta strains, while still observing a lag for Omicron and less severe CPE.

The apparent discrepancies between groups in reported relative severity of CPE in Vero E6 cells as a result of infection by different strains is not unexpected and likely results from non-universal culture conditions, sample sources, and handling. Thus, to further confirm the correlations revealed herein based on in vitro studies performed in a single lab, there may be value in collaborating with other labs to collect images of SARS-CoV-2 infected cultures and subject them to CNN-based analysis.

In future studies, an image analysis system such as described herein may be applied to determine correlations not only between variants, but sub-variants to assess if patterns of CPE change with specific mutations. Such expanded studies may contribute to understanding of increased or decreased replication, infectivity, and/or lethality as the viral genome evolves over the course of a pandemic. If applied to novel variants, such a method of analysis may predict which new variants have the potential to become predominant.

The exemplary systems and methods and/or uses of this invention have been described in relation to assessing performance of CNNs in processing images of assay wells of strains of viruses; however, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein. Any of the steps, functions, and operations discussed herein can be performed continuously and automatically.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods and/or uses of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

A neural network, as described herein may comprise layers of logical nodes having an input and an output. If an output is below a self-determined threshold level, the output may be omitted (i.e., the inputs may be within an inactive response portion of a scale and provide no output), if an output is above the threshold, the output may be provided (i.e., the inputs may be within the active response portion of the scale and provide the output). The particular placement of active and inactive delineation may be provided as a step or steps. Multiple inputs into a node may produce a multi-dimensional plane (e.g., hyperplane) to delineate a combination of inputs that are active or inactive.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, uses, processes, systems and/or apparatus substantially as depicted and described herein, including various embodiments, sub combinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to conduct one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof may be limited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally, or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud,” multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of QUALCOMM® SNAPDRAGON® 800 and 801, QUALCOMM® SNAPDRAGON® 610 and 615 with 4G LTE Integration and 64-bit computing, APPLE® A7 microprocessor with 64-bit architecture, APPLE® M7 motion microprocessors, SAMSUNG® EXYNOS® series, the INTEL® CORE™ family of microprocessors, the INTEL® XEON® family of microprocessors, the INTEL® ATOM™ family of microprocessors, the INTEL® ITANIUM® family of microprocessors, INTEL® CORE® i5-4670K and i7-4770K 22 nm Haswell, INTEL® CORE® i5-3570K 22 nm Ivy Bridge, the AMD® FX™ family of microprocessors, AMD® FX-4300, FX-6300, and FX-8350 32 nm Vishera, AMD® Kaveri microprocessors, TEXAS INSTRUMENTS® JACINTO C6000™ automotive infotainment microprocessors, TEXAS INSTRUMENTS® OMAP™ automotive-grade mobile microprocessors, ARM® CORTEX™-M microprocessors, ARM® Cortex-A and ARM926EJ-S™ microprocessors, other industry-equivalent microprocessors, and may perform computational functions using any known or future-developed standard, instruction set, libraries, and/or architecture.

Embodiments include a computer-based method, comprising: generating, by one or more processors operating on digital data stored in a memory device, a first one or more augmented images based on a first image; processing, by the one or more processors, using one or more neural networks, each of the first one or more augmented images and the first image, wherein each of the neural networks generates a descriptor for each of the first one or more augmented images and the first image; determining, by the one or more processors, for each of the neural networks, a fitness metric associated with the descriptor for each of the first one or more augmented images and the descriptor for the first image; and determining, by the one or more processors, a performance of a respective neural network of the one or more neural networks based on the determined fitness metric for the respective neural network.

Embodiments further include a computer-based method, comprising: processing, by one or more processors operating on digital data stored in a memory device, using one or more neural networks, a plurality of images, wherein each image is associated with one of a plurality of variants; generating, by the one or more processors, with the one or more neural networks, an association of each image with one of a plurality of clusters; generating, by the one or more processors, a correlation coefficient representing a correlation between one or more sets of two or more of the plurality of variants and the association of each image with one of the clusters; and based on the generated correlation between one or more sets of two or more variant labels and the association of each image with one of the clusters, determining, by the one or more processors, a degree of correlation between a first variant and a second variant of the plurality of variants.

Embodiments further include a computer-based method, comprising: generating, by one or more processors operating on digital data stored in a memory device, a first one or more augmented images based on a first image; processing, by the one or more processors, using two or more neural networks, each of the first one or more augmented images and the first image, wherein each of the neural networks generates a descriptor for each of the first one or more augmented images and the first image; determining, by the one or more processors, for each of the two or more neural networks, a fitness metric for each of the first one or more augmented images and the descriptor for the first image; determining, by the one or more processors, a performance of each of the two or more neural networks based on the determined fitness metric for the respective neural network; based on the determined performance of each of the two or more neural networks, selecting, by the one or more processors, one or more neural networks; processing, by the one or more processors, using the selected one or more neural networks, a plurality of images, wherein each image is associated with one of a plurality of variants; generating, by the one or more processors, with the selected one or more neural networks, an association of each image of the plurality of images with one of a plurality of clusters; generating by the one or more processors, a correlation coefficient representing a correlation between one or more sets of two or more of the plurality of variants and the association of each image with one of the clusters; and based on the generated correlation between one or more sets of two or more variant labels and the association of each image of the plurality of images with one of the clusters, determining, by the one or more processors, a degree of correlation between a first variant and a second variant of the plurality of variants.

Aspects of the above methods include wherein the fitness metric is a Euclidean distance between the descriptor for each of the first one or more augmented images and the descriptor for the first image.

Aspects of the above methods include wherein the performance of the respective neural network of the one or more neural networks is determined using a k-nearest neighbors algorithm.

Aspects of the above methods include wherein the generated descriptor for each of the first one or more augmented images and the first image comprises a plurality of bins, wherein determining the Euclidean distance between the generated descriptor for each of the first one or more augmented images and the generated descriptor for the first image comprises determining a difference between values of each of the bins.

Aspects of the above methods include wherein the first image comprises an image resulting from a tissue culture infectious dose (TCID) assay, wherein the performance of each of the one or more neural networks is associated with a capability of assessing viral cytotoxicity.

Aspects of the above methods include generating, by the one or more processors, a second one or more augmented images based on a second image; processing, by the one or more processors, using the one or more neural networks, each of the second one or more augmented images and the second image, wherein each of the neural networks generates a descriptor for each of the second one or more augmented images and the second image; and determining, by the one or more processors, for each of the neural networks, a Euclidean distance between the descriptor for each of the second one or more augmented images and the descriptor for the second image, wherein determining the performance of the respective neural network is further based on the determined Euclidean distance for the respective neural network.

Aspects of the above methods include wherein determining the performance of each of the one or more neural networks comprises identifying generated descriptors with a smallest Euclidean distance from each of the generated descriptors for each of the first and second images.

Aspects of the above methods include wherein the descriptor generated by a highest performing neural network for each of the first one or more augmented images has a smaller Euclidean distance from the descriptor for the first image than from the descriptor for the second image.

Aspects of the above methods include wherein the performance of the respective neural network is determined by determining each of the descriptors for each of the augmented images based on the first image are nearest neighbors to the descriptor for the first image.

Aspects of the above methods include ranking, by the one or more processors, the one or more neural networks based on the determined performance.

Aspects of the above methods include, prior to processing each image, performing, by the one or more processors, one or more transforms of the first image.

Aspects of the above methods include wherein the one or more transforms comprises converting the first image to greyscale.

Aspects of the above methods include, prior to processing each image, determining, by the one or more processors, a whiteness metric for each of the images.

Aspects of the above methods include wherein the whiteness metric comprises one or more of a percentage of white pixels and a standard deviation.

Aspects of the above methods include removing, by the one or more processors, images without at least one of a percentage of white pixels less than 75 and a standard deviation of 0.1.

Aspects of the above methods include wherein generating the augmented images comprises one or more of performing a rotation, a flip, a random rotation, a shift, and a shear of the first image.

Aspects of the above methods include wherein generating the augmented images comprises creating rotated and/or flipped versions of the first image.

Aspects of the above methods include wherein generating the augmented images comprises generating four rotated versions of the first image and two flipped versions of the first image.

Aspects of the above methods include wherein the plurality of variants comprises strains of a virus, and wherein the degree of correlation between the first variant and the second variant indicates a pattern of cytotoxicity.

Aspects of the above methods include training, by the one or more processors, the one or more neural networks to generate a variant label estimate for input images.

Aspects of the above methods include augmenting, by the one or more processors, the images.

Aspects of the above methods include wherein augmenting the images comprises one or more of rotating and/or flipping the images.

Aspects of the above methods include using, by the one or more processors, the one or more neural networks to associate each image and each augmented image with a cluster.

Aspects of the above methods include wherein augmenting the images comprises generating four rotated versions of the first image and two flipped versions of each image.

Aspects of the above methods include wherein augmenting images comprises one or more of performing a rotation, a flip, a random rotation, a shift, and a shear of each image.

Aspects of the above methods include wherein processing the images comprises performing k-means clustering, and wherein the method comprises comparing, by the one or more processors, results of clustering using different k values.

Aspects of the above methods include wherein the one or more neural networks comprises two or more neural networks, and wherein each neural network generates a different association of each image with one of the plurality of clusters.

Aspects of the above methods include wherein an output of each of the two or more neural networks is used to generate a different correlation coefficient representing the correlation between one or more sets of two or more variant labels and the different association of each image.

Aspects of the above methods include comparing, by the one or more processors, a correlation coefficient generated based on the association of each image with one of the plurality of clusters generated with a first neural network of the one or more neural networks with the association of each image with one of the plurality of clusters generated with a second neural network of the one or more neural networks.

Aspects of the above methods include averaging, by the one or more processors, a correlation coefficient generated based on the association of each image with one of the plurality of clusters generated with a first neural network of the one or more neural networks with the association of each image with one of the plurality of clusters generated with a second neural network of the one or more neural networks.

Aspects of the above methods include wherein the correlations represent cytopathic effect spatial pattern correlations.

This disclosure includes one or more means for performing any one or more of the above embodiments or aspects of the embodiments are described herein.

This disclosure includes any aspect in combination with any one or more other aspects.

This disclosure includes any one or more of the features disclosed herein.

This disclosure includes any one or more of the features as substantially disclosed herein.

This disclosure includes any one or more of the features as substantially disclosed herein in combination with any one or more other features as substantially disclosed herein.

This disclosure includes any one of the aspects/features/embodiments in combination with any one or more other aspects/features/embodiments.

This disclosure provides the use of any one or more of the aspects or features as disclosed herein.

It is to be appreciated that any feature described herein can be claimed in combination with any other feature(s) as described herein, regardless of whether the features come from the same described embodiment.

What is claimed is:

1. A computer-based method, comprising:
generating, by one or more processors operating on digital data stored in a memory device, a first one or more augmented images based on a first image;
processing, by the one or more processors, using one or more neural networks, each of the first one or more augmented images and the first image, wherein each of the neural networks generates a descriptor for each of the first one or more augmented images and the first image;
determining, by the one or more processors, for each of the neural networks, a fitness metric associated with the descriptor for each of the first one or more augmented images and the descriptor for the first image; and
determining, by the one or more processors, a performance of a respective neural network of the one or more neural networks based on the determined fitness metric for the respective neural network.

2. The method of claim 1, wherein the fitness metric is a Euclidean distance between the descriptor for each of the first one or more augmented images and the descriptor for the first image.

3. The method of claim 1, wherein the performance of the respective neural network of the one or more neural networks is determined using a k-nearest neighbors algorithm.

4. The method of claim 1, wherein the generated descriptor for each of the first one or more augmented images and the first image comprises a plurality of bins, wherein determining the fitness metric associated with the descriptor for each of the first one or more augmented images and the generated descriptor for the first image comprises determining a difference between values of each of the bins.

5. The method of claim 1, wherein the first image comprises an image resulting from a tissue culture infectious dose (TCID) assay, wherein the performance of each of the one or more neural networks is associated with a capability of assessing viral cytotoxicity.

6. The method of claim 1, further comprising:
generating, by the one or more processors, a second one or more augmented images based on a second image;
processing, by the one or more processors, using the one or more neural networks, each of the second one or more augmented images and the second image, wherein each of the neural networks generates a descriptor for each of the second one or more augmented images and the second image; and
determining, by the one or more processors, for each of the neural networks, a Euclidean distance between the descriptor for each of the second one or more augmented images and the descriptor for the second image,
wherein determining the performance of the respective neural network is further based on the determined Euclidean distance for the respective neural network.

7. The method of claim 6, wherein determining the performance of each of the one or more neural networks comprises identifying generated descriptors with a smallest Euclidean distance from each of the generated descriptors for each of the first and second images.

8. The method of claim 7, wherein the descriptor generated by a highest performing neural network for each of the first one or more augmented images has a smaller Euclidean distance from the descriptor for the first image than from the descriptor for the second image.

9. The method of claim 1, wherein the performance of the respective neural network is determined by determining each of the descriptors for each of the augmented images based on the first image are nearest neighbors to the descriptor for the first image.

10. The method of claim 1, further comprising ranking, by the one or more processors, the one or more neural networks based on the determined performance.

11. The method of claim 1, further comprising, prior to processing each image, performing, by the one or more processors, one or more transforms of the first image.

12. The method of claim 11, wherein the one or more transforms comprises converting the first image to greyscale.

13. The method of claim 12, further comprising, prior to processing each image, determining, by the one or more processors, a whiteness metric for each of the images.

14. The method of claim 13, wherein the whiteness metric comprises one or more of a percentage of white pixels and a standard deviation.

15. The method of claim 14, further comprising removing, by the one or more processors, images without at least one of a percentage of white pixels less than 75 and a standard deviation of 0.1.

16. The method of claim 1, wherein generating the augmented images comprises one or more of performing a rotation, a flip, a random rotation, a shift, and a shear of the first image.

17. The method of claim 1, wherein generating the augmented images comprises creating rotated and/or flipped versions of the first image.

18. The method of claim 1, wherein generating the augmented images comprises generating four rotated versions of the first image and two flipped versions of the first image.

19. A computer-based method, comprising:
processing, by one or more processors operating on digital data stored in a memory device, using one or more neural networks, a plurality of images, wherein each image is associated with one of a plurality of variants;
generating, by the one or more processors, with the one or more neural networks, an association of each image with one of a plurality of clusters;
generating, by the one or more processors, a correlation coefficient representing a correlation between one or more sets of two or more of the plurality of variants and the association of each image with one of the clusters; and
based on the generated correlation between one or more sets of two or more variant labels and the association of each image with one of the clusters, determining, by the one or more processors, a degree of correlation between a first variant and a second variant of the plurality of variants.

20. A computer-based method, comprising:
generating, by one or more processors operating on digital data stored in a memory device, a first one or more augmented images based on a first image;
processing, by the one or more processors, using two or more neural networks, each of the first one or more augmented images and the first image, wherein each of the neural networks generates a descriptor for each of the first one or more augmented images and the first image;
determining, by the one or more processors, for each of the two or more neural networks, a Euclidean distance between the descriptor for each of the first one or more augmented images and the descriptor for the first image;
determining, by the one or more processors, a performance of each of the two or more neural networks based on the determined Euclidean distances for the respective neural network;
based on the determined performance of each of the two or more neural networks, selecting, by the one or more processors, one or more neural networks;
processing, by the one or more processors, using the selected one or more neural networks, a plurality of images, wherein each image is associated with one of a plurality of variants;
generating, by the one or more processors, with the selected one or more neural networks, an association of each image of the plurality of images with one of a plurality of clusters;
generating by the one or more processors, a correlation coefficient representing a correlation between one or more sets of two or more of the plurality of variants and the association of each image with one of the clusters; and
based on the generated correlation coefficient representing the correlation between the one or more sets of two or more variant labels and the association of each image of the plurality of images with one of the clusters, determining, by the one or more processors, a degree of correlation between a first variant and a second variant of the plurality of variants.
